(19) United States
(12) Patent Application Publication
(10) Pub. No.: US 2025/0365389 A1
(43) Pub. Date: Nov. 27, 2025

(54) IMAGE ENCODING/DECODING METHOD, METHOD FOR TRANSMITTING BITSTREAM, AND RECORDING MEDIUM IN WHICH BITSTREAM IS STORED

(71) Applicant: LG Electronics Inc., Seoul (KR)

(72) Inventors: Jung Hak NAM, Seoul (KR); Sunmi YOO, Seoul (KR); Jaehyun LIM, Seoul (KR); Seung Hwan KIM, Seoul (KR)

(21) Appl. No.: 18/689,345

(22) PCT Filed: Sep. 23, 2022
(86) PCT No.: PCT/KR2022/014252

§ 371 Date: Mar. 5, 2024

Related U.S. Application Data
(60) Provisional application No. 63/247,320, filed on Sep. 23, 2021.

(51) Int. Cl. H04N 7/01; H04N 19/513

(52) U.S. Cl. CPC H04N 7/0117; H04N 19/521

(57) ABSTRACT

An image encoding/decoding method, a bitstream transmission method, and a computer-readable recording medium for storing a bitstream are provided. A method by which an image decoding device decodes an image, according to the present disclosure, comprises the steps of: acquiring, from a bitstream, resolution information about the current image; determining, on the basis of the resolution information, the resolution to be applied to the current image; and changing the resolution of the current image to the determined resolution.

### CROSS-REFERENCE TO RELATED APPLICATIONS

This application is a National Stage application under 35 U.S.C. § 371 of International Application No. PCT/KR2022/014252, filed on Sep. 23, 2022, which claims the benefit of U.S. Provisional Application No. 63/247,320, filed on Sep. 23, 2021. The disclosures of the prior applications are incorporated by reference in their entirety.

### TECHNICAL FIELD

The present disclosure relates to an image encoding/decoding method, a method of transmitting a bitstream and a recording medium storing a bitstream and relates to reference picture resampling (RPR).

### BACKGROUND

Recently, demand for high-resolution and high-quality images such as high definition (HD) images and ultra high definition (UHD) images is increasing in various fields. As resolution and quality of image data are improved, the amount of transmitted information or bits relatively increases as compared to existing image data. An increase in the amount of transmitted information or bits causes an increase in transmission cost and storage cost.

Accordingly, there is a need for high-efficient image compression technology for effectively transmitting, storing and reproducing information on high-resolution and high-quality images.

### SUMMARY

An object of the present disclosure is to provide an image encoding/decoding method and apparatus with improved encoding/decoding efficiency.

An object of the present disclosure is to provide a method of signaling information on an optimal resolution.

An object of the present disclosure is to provide a method of adaptively adjusting a quantization parameter.

An object of the present disclosure is to provide a method of adaptively determining whether to use various coding tools.

An object of the present disclosure is to provide a method of determining whether to apply a resampling filter, chroma sampling format and dual tree for adaptive resolution change.

Another object of the present disclosure is to provide a non-transitory computer-readable recording medium storing a bitstream generated by an image encoding method according to the present disclosure.

Another object of the present disclosure is to provide a non-transitory computer-readable recording medium storing a bitstream received, decoded and used to reconstruct an image by an image decoding apparatus according to the present disclosure.

Another object of the present disclosure is to provide a method of transmitting a bitstream generated by an image encoding method or apparatus according to the present disclosure.

The technical problems solved by the present disclosure are not limited to the above technical problems and other technical problems which are not described herein will become apparent to those skilled in the art from the following description.

An image decoding method according to an aspect of the present disclosure may be an image decoding method performed by an image decoding apparatus, which comprises obtaining resolution information of a current image from a bitstream, determining a resolution to be applied to the current image based on the resolution information, and changing a resolution of the current image to the determined resolution.

An image encoding method according to another aspect of the present disclosure may be an image encoding method performed by an image encoding apparatus, which comprises determining whether a resolution of a current image is changed, determining a resolution to be changed of the current image based on determining that the resolution of the current image is changed, and encoding resolution information specifying the determined resolution. By comparing a quantization parameter value of the current image with a predetermined quantization parameter value, it may be determined whether the resolution of the current image is changed.

A computer-readable recording medium according to another aspect of the present disclosure may store a bitstream generated by the image encoding device or apparatus of the present disclosure.

A transmission method according to another aspect of the present disclosure may transmit a bitstream generated by the image encoding method or apparatus of the present disclosure.

The features briefly summarized above with respect to the present disclosure are merely exemplary aspects of the detailed description below of the present disclosure, and do not limit the scope of the present disclosure.

According to the present disclosure, it is possible to provide an image encoding/decoding method and apparatus with improved encoding/decoding efficiency.

According to the present disclosure, it is possible to efficiently signal information on an optimal resolution.

According to the present disclosure, since a quantization parameter, whether to use coding tools, chroma sampling format, and whether to apply a dual tree may be adaptively determined, it is possible to improve efficiency of encoding and decoding.

It will be appreciated by persons skilled in the art that that the effects that can be achieved through the present disclosure are not limited to what has been particularly described hereinabove and other advantages of the present disclosure will be more clearly understood from the detailed description.

### BRIEF DESCRIPTION OF THE DRAWINGS

FIG. 1 is a view schematically illustrating a video coding system, to which an embodiment of the present disclosure is applicable.

FIG. 2 is a view schematically illustrating an image encoding apparatus, to which an embodiment of the present disclosure is applicable.

FIG. 3 is a view schematically illustrating an image decoding apparatus, to which an embodiment of the present disclosure is applicable.

FIG. 4 is a diagram showing an example of partitioning a picture into CTUs.

FIG. 5 is a diagram showing examples of partitioning a picture into tiles, slices and/or bricks.

FIG. 6 is a flowchart illustrating an image encoding method according to an embodiment of the present disclosure.

FIG. 7 is a flowchart illustrating an image decoding method according to an embodiment of the present disclosure.

FIG. 8 is a flowchart illustrating an image encoding method according to another embodiment of the present disclosure.

FIG. 9 is a flowchart illustrating an image decoding method according to another embodiment of the present disclosure.

FIG. 10 is a flowchart illustrating an image encoding method according to another embodiment of the present disclosure.

FIG. 11 is a flowchart illustrating an image decoding method according to another embodiment of the present disclosure.

FIG. 12 is a flowchart illustrating an image encoding method according to another embodiment of the present disclosure.

FIG. 13 is a flowchart illustrating an image decoding method according to another embodiment of the present disclosure.

FIG. 14 is a flowchart illustrating an image encoding method according to another embodiment of the present disclosure.

FIG. 15 is a flowchart illustrating an image decoding method according to another embodiment of the present disclosure.

FIG. 16 is a flowchart illustrating an image encoding method according to another embodiment of the present disclosure.

FIG. 17 is a flowchart illustrating an image decoding method according to another embodiment of the present disclosure.

FIG. 18 is a view illustrating a content streaming system, to which an embodiment of the present disclosure is applicable.

### DETAILED DESCRIPTION

Hereinafter, the embodiments of the present disclosure will be described in detail with reference to the accompanying drawings so as to be easily implemented by those skilled in the art. However, the present disclosure may be implemented in various different forms, and is not limited to the embodiments described herein.

In describing the present disclosure, if it is determined that the detailed description of a related known function or construction renders the scope of the present disclosure unnecessarily ambiguous, the detailed description thereof will be omitted. In the drawings, parts not related to the description of the present disclosure are omitted, and similar reference numerals are attached to similar parts.

In the present disclosure, when a component is “connected”, “coupled” or “linked” to another component, it may include not only a direct connection relationship but also an indirect connection relationship in which an intervening component is present. In addition, when a component “includes” or “has” other components, it means that other components may be further included, rather than excluding other components unless otherwise stated.

In the present disclosure, the terms first, second, etc, may be used only for the purpose of distinguishing one component from other components, and do not limit the order or importance of the components unless otherwise stated. Accordingly, within the scope of the present disclosure, a first component in one embodiment may be referred to as a second component in another embodiment, and similarly, a second component in one embodiment may be referred to as a first component in another embodiment.

In the present disclosure, components that are distinguished from each other are intended to clearly describe each feature, and do not mean that the components are necessarily separated. That is, a plurality of components may be integrated and implemented in one hardware or software unit, or one component may be distributed and implemented in a plurality of hardware or software units. Therefore, even if not stated otherwise, such embodiments in which the components are integrated or the component is distributed are also included in the scope of the present disclosure.

In the present disclosure, the components described in various embodiments do not necessarily mean essential components, and some components may be optional components. Accordingly, an embodiment consisting of a subset of components described in an embodiment is also included in the scope of the present disclosure. In addition, embodiments including other components in addition to components described in the various embodiments are included in the scope of the present disclosure.

The present disclosure relates to encoding and decoding of an image, and terms used in the present disclosure may have a general meaning commonly used in the technical field, to which the present disclosure belongs, unless newly defined in the present disclosure.

In the present disclosure, a “picture” generally refers to a unit representing one image in a specific time period, and a slice/tile is a coding unit constituting a part of a picture, and one picture may be composed of one or more slices/tiles. In addition, a slice/tile may include one or more coding tree units (CTUs).

In the present disclosure, a “pixel” or a “pel” may mean a smallest unit constituting one picture (or image). In addition, “sample” may be used as a term corresponding to a pixel. A sample may generally represent a pixel or a value of a pixel, and may represent only a pixel/pixel value of a luma component or only a pixel/pixel value of a chroma component.

In the present disclosure, a “unit” may represent a basic unit of image processing. The unit may include at least one of a specific region of the picture and information related to the region. The unit may be used interchangeably with terms such as “sample array”, “block” or “area” in some cases. In a general case, an M×N block may include samples (or sample arrays) or a set (or array) of transform coefficients of M columns and N rows.

In the present disclosure, “current block” may mean one of “current coding block”, “current coding unit”, “coding target block”, “decoding target block” or “processing target block”. When prediction is performed, “current block” may mean “current prediction block” or “prediction target block”. When transform (inverse transform)/quantization (dequantization) is performed, “current block” may mean “current transform block” or “transform target block”. When filtering is performed, “current block” may mean “filtering target block”.

In addition, in the present disclosure, a “current block” may mean a block including both a luma component block and a chroma component block or “a luma block of a current block” unless explicitly stated as a chroma block. The luma component block of the current block may be expressed by including an explicit description of a luma component block such as “luma block” or “current luma block. In addition, the “chroma component block of the current block” may be expressed by including an explicit description of a chroma component block, such as “chroma block” or “current chroma block”.

In the present disclosure, the term “/” and “,” should be interpreted to indicate “and/or.” For instance, the expression “A/B” and “A, B” may mean “A and/or B.” Further, “A/B/C” and “A/B/C” may mean “at least one of A, B, and/or C.”

In the present disclosure, the term “or” should be interpreted to indicate “and/or.” For instance, the expression “A or B” may comprise 1) only “A”, 2) only “B”, and/or 3) both “A and B”. In other words, in the present disclosure, the term “or” should be interpreted to indicate “additionally or alternatively.”

### Overview of Video Coding System

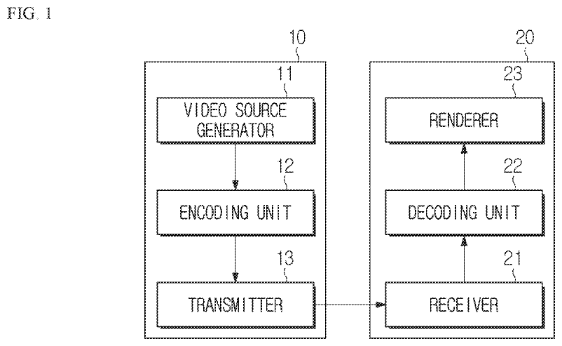

FIG. 1 is a view schematically illustrating a video coding system, to which an embodiment of the present disclosure is applicable.

The video coding system according to an embodiment may include a encoding apparatus 10 and a decoding apparatus 20. The encoding apparatus 10 may deliver encoded video and/or image information or data to the decoding apparatus 20 in the form of a file or streaming via a digital storage medium or network.

The encoding apparatus 10 according to an embodiment may include a video source generator 11, an encoding unit 12 and a transmitter 13. The decoding apparatus 20 according to an embodiment may include a receiver 21, a decoding unit 22 and a renderer 23. The encoding unit 12 may be called a video/image encoding unit, and the decoding unit 22 may be called a video/image decoding unit. The transmitter 13 may be included in the encoding unit 12. The receiver 21 may be included in the decoding unit 22. The renderer 23 may include a display and the display may be configured as a separate device or an external component.

The video source generator 11 may acquire a video/image through a process of capturing, synthesizing or generating the video/image. The video source generator 11 may include a video/image capture device and/or a video/image generating device. The video/image capture device may include, for example, one or more cameras, video/image archives including previously captured video/images, and the like. The video/image generating device may include, for example, computers, tablets and smartphones, and may (electronically) generate video/images. For example, a virtual video/image may be generated through a computer or the like. In this case, the video/image capturing process may be replaced by a process of generating related data.

The encoding unit 12 may encode an input video/image. The encoding unit 12 may perform a series of procedures such as prediction, transform, and quantization for compression and coding efficiency. The encoding unit 12 may output encoded data (encoded video/image information) in the form of a bitstream.

The transmitter 13 may obtain the encoded video/image information or data output in the form of a bitstream and transfer it to the receiver 21 of the decoding apparatus 20 or another external object through a digital storage medium or a network in the form of a file or streaming. The digital storage medium may include various storage mediums such as USB, SD, CD, DVD, Blu-ray, HDD, SSD, and the like. The transmitter 13 may include an element for generating a media file through a predetermined file format and may include an element for transmission through a broadcast/communication network. The transmitter 13 may be provided as a separate transmission device from the encoding apparatus 12. In this case, the transmission device includes at least one processor for obtaining encoded video/image information or data output in the form of a bitstream and a transmitter for transferring it in the form of a file or streaming. The receiver 21 may extract/receive the bitstream from the storage medium or network and transfer the bitstream to the decoding unit 22.

The decoding unit 22 may decode the video/image by performing a series of procedures such as dequantization, inverse transform, and prediction corresponding to the operation of the encoding unit 12.

The renderer 23 may render the decoded video/image. The rendered video/image may be displayed through the display.

### Overview of Image Encoding Apparatus

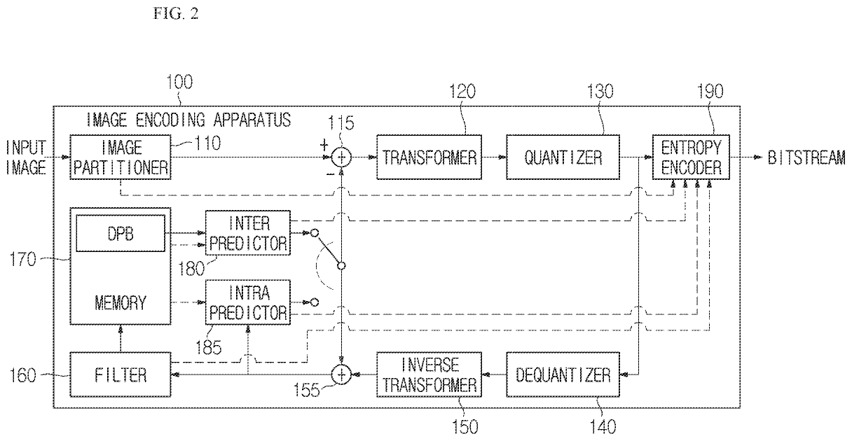

FIG. 2 is a view schematically illustrating an image encoding apparatus, to which an embodiment of the present disclosure is applicable.

As shown in FIG. 2, the image encoding apparatus 100 may include an image partitioner 110, a subtractor 115, a transformer 120, a quantizer 130, a dequantizer 140, an inverse transformer 150, an adder 155, a filter 160, a memory 170, an inter predictor 180, an intra predictor 185 and an entropy encoder 190. The inter predictor 180 and the intra predictor 185 may be collectively referred to as a “predictor”. The transformer 120, the quantizer 130, the dequantizer 140 and the inverse transformer 150 may be included in a residual processor. The residual processor may further include the subtractor 115.

All or at least some of the plurality of components configuring the image encoding apparatus 100 may be configured by one hardware component (e.g., an encoder or a processor) in some embodiments. In addition, the memory 170 may include a decoded picture buffer (DPB) and may be configured by a digital storage medium.

The image partitioner 110 may partition an input image (or a picture or a frame) input to the image encoding apparatus 100 into one or more processing units. For example, the processing unit may be called a coding unit (CU). The coding unit may be acquired by recursively partitioning a coding tree unit (CTU) or a largest coding unit (LCU) according to a quad-tree binary-tree ternary-tree (QT/BT/TT) structure. For example, one coding unit may be partitioned into a plurality of coding units of a deeper depth based on a quad tree structure, a binary tree structure, and/or a ternary structure. For partitioning of the coding unit, a quad tree structure may be applied first and the binary tree structure and/or ternary structure may be applied later. The coding procedure according to the present disclosure may be performed based on the final coding unit that is no longer partitioned. The largest coding unit may be used as the final coding unit or the coding unit of deeper depth acquired by partitioning the largest coding unit may be used as the final coding unit. Here, the coding procedure may include a procedure of prediction, transform, and reconstruction, which will be described later. As another example, the processing unit of the coding procedure may be a prediction unit (PU) or a transform unit (TU). The prediction unit and the transform unit may be split or partitioned from the final coding unit. The prediction unit may be a unit of sample prediction, and the transform unit may be a unit for deriving a transform coefficient and/or a unit for deriving a residual signal from the transform coefficient.

The predictor (the inter predictor 180 or the intra predictor 185) may perform prediction on a block to be processed (current block) and generate a predicted block including prediction samples for the current block. The predictor may determine whether intra prediction or inter prediction is applied on a current block or CU basis. The predictor may generate various information related to prediction of the current block and transmit the generated information to the entropy encoder 190. The information on the prediction may be encoded in the entropy encoder 190 and output in the form of a bitstream.

The intra predictor 185 may predict the current block by referring to the samples in the current picture. The referred samples may be located in the neighborhood of the current block or may be located apart according to the intra prediction mode and/or the intra prediction technique. The intra prediction modes may include a plurality of non-directional modes and a plurality of directional modes. The non-directional mode may include, for example, a DC mode and a planar mode. The directional mode may include, for example, 33 directional prediction modes or 65 directional prediction modes according to the degree of detail of the prediction direction. However, this is merely an example, more or less directional prediction modes may be used depending on a setting. The intra predictor 185 may determine the prediction mode applied to the current block by using a prediction mode applied to a neighboring block.

The inter predictor 180 may derive a predicted block for the current block based on a reference block (reference sample array) specified by a motion vector on a reference picture. In this case, in order to reduce the amount of motion information transmitted in the inter prediction mode, the motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. The reference picture including the reference block and the reference picture including the temporal neighboring block may be the same or different. The temporal neighboring block may be called a collocated reference block, a co-located CU (colCU), and the like. The reference picture including the temporal neighboring block may be called a collocated picture (colPic). For example, the inter predictor 180 may configure a motion information candidate list based on neighboring blocks and generate information indicating which candidate is used to derive a motion vector and/or a reference picture index of the current block. Inter prediction may be performed based on various prediction modes. For example, in the case of a skip mode and a merge mode, the inter predictor 180 may use motion information of the neighboring block as motion information of the current block. In the case of the skip mode, unlike the merge mode, the residual signal may not be transmitted. In the case of the motion vector prediction (MVP) mode, the motion vector of the neighboring block may be used as a motion vector predictor, and the motion vector of the current block may be signaled by encoding a motion vector difference and an indicator for a motion vector predictor. The motion vector difference may mean a difference between the motion vector of the current block and the motion vector predictor.

The predictor may generate a prediction signal based on various prediction methods and prediction techniques described below. For example, the predictor may not only apply intra prediction or inter prediction but also simultaneously apply both intra prediction and inter prediction, in order to predict the current block. A prediction method of simultaneously applying both intra prediction and inter prediction for prediction of the current block may be called combined inter and intra prediction (CIIP). In addition, the predictor may perform intra block copy (IBC) for prediction of the current block. Intra block copy may be used for content image/video coding of a game or the like, for example, screen content coding (SCC). IBC is a method of predicting a current picture using a previously reconstructed reference block in the current picture at a location apart from the current block by a predetermined distance. When IBC is applied, the location of the reference block in the current picture may be encoded as a vector (block vector) corresponding to the predetermined distance. IBC basically performs prediction in the current picture, but may be performed similarly to inter prediction in that a reference block is derived within the current picture. That is. IBC may use at least one of the inter prediction techniques described in the present disclosure.

The prediction signal generated by the predictor may be used to generate a reconstructed signal or to generate a residual signal. The subtractor 115 may generate a residual signal (residual block or residual sample array) by subtracting the prediction signal (predicted block or prediction sample array) output from the predictor from the input image signal (original block or original sample array). The generated residual signal may be transmitted to the transformer 120.

The transformer 120 may generate transform coefficients by applying a transform technique to the residual signal. For example, the transform technique may include at least one of a discrete cosine transform (DCT), a discrete sine transform (DST), a karhunen-loève transform (KLT), a graph-based transform (GBT), or a conditionally non-linear transform (CNT). Here, the GBT means transform obtained from a graph when relationship information between pixels is represented by the graph. The CNT refers to transform acquired based on a prediction signal generated using all previously reconstructed pixels. In addition, the transform process may be applied to square pixel blocks having the same size or may be applied to blocks having a variable size rather than square.

The quantizer 130 may quantize the transform coefficients and transmit them to the entropy encoder 190. The entropy encoder 190 may encode the quantized signal (information on the quantized transform coefficients) and output a bitstream. The information on the quantized transform coefficients may be referred to as residual information. The quantizer 130 may rearrange quantized transform coefficients in a block type into a one-dimensional vector form based on a coefficient scanning order and generate information on the quantized transform coefficients based on the quantized transform coefficients in the one-dimensional vector form.

The entropy encoder 190 may perform various encoding methods such as, for example, exponential Golomb, context-adaptive variable length coding (CAVLC), context-adaptive binary arithmetic coding (CABAC), and the like. The entropy encoder 190 may encode information necessary for video/image reconstruction other than quantized transform coefficients (e.g., values of syntax elements, etc.) together or separately. Encoded information (e.g., encoded video/image information) may be transmitted or stored in units of network abstraction layers (NALs) in the form of a bitstream. The video/image information may further include information on various parameter sets such as an adaptation parameter set (APS), a picture parameter set (PPS), a sequence parameter set (SPS), or a video parameter set (VPS). In addition, the video/image information may further include general constraint information. The signaled information, transmitted information and/or syntax elements described in the present disclosure may be encoded through the above-described encoding procedure and included in the bitstream.

The bitstream may be transmitted over a network or may be stored in a digital storage medium. The network may include a broadcasting network and/or a communication network. and the digital storage medium may include various storage media such as USB, SD, CD, DVD, Blu-ray, HDD, SSD, and the like. A transmitter (not shown) transmitting a signal output from the entropy encoder 190 and/or a storage unit (not shown) storing the signal may be included as internal/external element of the image encoding apparatus 100. Alternatively, the transmitter may be provided as the component of the entropy encoder 190.

The quantized transform coefficients output from the quantizer 130 may be used to generate a residual signal. For example, the residual signal (residual block or residual samples) may be reconstructed by applying dequantization and inverse transform to the quantized transform coefficients through the dequantizer 140 and the inverse transformer 150.

The adder 155 adds the reconstructed residual signal to the prediction signal output from the inter predictor 180 or the intra predictor 185 to generate a reconstructed signal (reconstructed picture, reconstructed block, reconstructed sample array). If there is no residual for the block to be processed, such as a case where the skip mode is applied, the predicted block may be used as the reconstructed block. The adder 155 may be called a reconstructor or a reconstructed block generator. The generated reconstructed signal may be used for intra prediction of a next block to be processed in the current picture and may be used for inter prediction of a next picture through filtering as described below.

The filter 160 may improve subjective/objective image quality by applying filtering to the reconstructed signal. For example, the filter 160 may generate a modified reconstructed picture by applying various filtering methods to the reconstructed picture and store the modified reconstructed picture in the memory 170, specifically, a DPB of the memory 170. The various filtering methods may include, for example, deblocking filtering, a sample adaptive offset, an adaptive loop filter, a bilateral filter, and the like. The filter 160 may generate various information related to filtering and transmit the generated information to the entropy encoder 190 as described later in the description of each filtering method. The information related to filtering may be encoded by the entropy encoder 190 and output in the form of a bitstream.

The modified reconstructed picture transmitted to the memory 170 may be used as the reference picture in the inter predictor 180. When inter prediction is applied through the image encoding apparatus 100, prediction mismatch between the image encoding apparatus 100 and the image decoding apparatus may be avoided and encoding efficiency may be improved.

The DPB of the memory 170 may store the modified reconstructed picture for use as a reference picture in the inter predictor 180. The memory 170 may store the motion information of the block from which the motion information in the current picture is derived (or encoded) and/or the motion information of the blocks in the picture that have already been reconstructed. The stored motion information may be transmitted to the inter predictor 180 and used as the motion information of the spatial neighboring block or the motion information of the temporal neighboring block. The memory 170 may store reconstructed samples of reconstructed blocks in the current picture and may transfer the reconstructed samples to the intra predictor 185.

### Overview of Image Decoding Apparatus

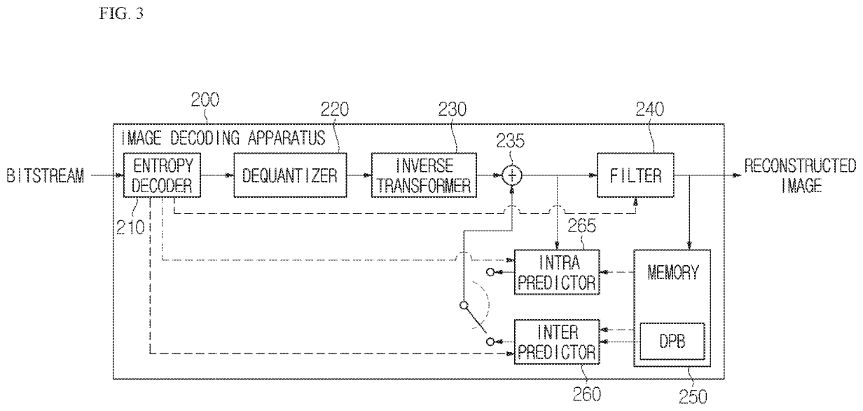

FIG. 3 is a view schematically illustrating an image decoding apparatus, to which an embodiment of the present disclosure is applicable.

As shown in FIG. 3, the image decoding apparatus 200 may include an entropy decoder 210, a dequantizer 220, an inverse transformer 230, an adder 235, a filter 240, a memory 250, an inter predictor 260 and an intra predictor 265. The inter predictor 260 and the intra predictor 265 may be collectively referred to as a “predictor”. The dequantizer 220 and the inverse transformer 230 may be included in a residual processor.

All or at least some of a plurality of components configuring the image decoding apparatus 200 may be configured by a hardware component (e.g., a decoder or a processor) according to an embodiment. In addition, the memory 250 may include a decoded picture buffer (DPB) or may be configured by a digital storage medium.

The image decoding apparatus 200, which has received a bitstream including video/image information, may reconstruct an image by performing a process corresponding to a process performed by the image encoding apparatus 100 of FIG. 2. For example, the image decoding apparatus 200 may perform decoding using a processing unit applied in the image encoding apparatus. Thus, the processing unit of decoding may be a coding unit, for example. The coding unit may be acquired by partitioning a coding tree unit or a largest coding unit. The reconstructed image signal decoded and output through the image decoding apparatus 200 may be reproduced through a reproducing apparatus (not shown).

The image decoding apparatus 200 may receive a signal output from the image encoding apparatus of FIG. 2 in the form of a bitstream. The received signal may be decoded through the entropy decoder 210. For example, the entropy decoder 210 may parse the bitstream to derive information (e.g., video/image information) necessary for image reconstruction (or picture reconstruction). The video/image information may further include information on various parameter sets such as an adaptation parameter set (APS), a picture parameter set (PPS), a sequence parameter set (SPS), or a video parameter set (VPS). In addition, the video/image information may further include general constraint information. The image decoding apparatus may further decode picture based on the information on the parameter set and/or the general constraint information. Signaled/received information and/or syntax elements described in the present disclosure may be decoded through the decoding procedure and obtained from the bitstream. For example, the entropy decoder 210 decodes the information in the bitstream based on a coding method such as exponential Golomb coding, CAVLC, or CABAC, and output values of syntax elements required for image reconstruction and quantized values of transform coefficients for residual. More specifically, the CABAC entropy decoding method may receive a bin corresponding to each syntax element in the bitstream, determine a context model using a decoding target syntax element information, decoding information of a neighboring block and a decoding target block or information of a symbol/bin decoded in a previous stage, and perform arithmetic decoding on the bin by predicting a probability of occurrence of a bin according to the determined context model, and generate a symbol corresponding to the value of each syntax element. In this case, the CABAC entropy decoding method may update the context model by using the information of the decoded symbol/bin for a context model of a next symbol/bin after determining the context model. The information related to the prediction among the information decoded by the entropy decoder 210) may be provided to the predictor (the inter predictor 260 and the intra predictor 265), and the residual value on which the entropy decoding was performed in the entropy decoder 210, that is, the quantized transform coefficients and related parameter information, may be input to the dequantizer 220. In addition, information on filtering among information decoded by the entropy decoder 210 may be provided to the filter 240. Meanwhile, a receiver (not shown) for receiving a signal output from the image encoding apparatus may be further configured as an internal/external element of the image decoding apparatus 200, or the receiver may be a component of the entropy decoder 210.

Meanwhile, the image decoding apparatus according to the present disclosure may be referred to as a video/image/picture decoding apparatus. The image decoding apparatus may be classified into an information decoder (video/image/picture information decoder) and a sample decoder (video/image/picture sample decoder). The information decoder may include the entropy decoder 210. The sample decoder may include at least one of the dequantizer 220, the inverse transformer 230, the adder 235, the filter 240, the memory 250, the inter predictor 160 or the intra predictor 265.

The dequantizer 220 may dequantize the quantized transform coefficients and output the transform coefficients. The dequantizer 220 may rearrange the quantized transform coefficients in the form of a two-dimensional block. In this case, the rearrangement may be performed based on the coefficient scanning order performed in the image encoding apparatus. The dequantizer 220 may perform dequantization on the quantized transform coefficients by using a quantization parameter (e.g., quantization step size information) and obtain transform coefficients.

The inverse transformer 230 may inversely transform the transform coefficients to obtain a residual signal (residual block, residual sample array).

The predictor may perform prediction on the current block and generate a predicted block including prediction samples for the current block. The predictor may determine whether intra prediction or inter prediction is applied to the current block based on the information on the prediction output from the entropy decoder 210 and may determine a specific intra/inter prediction mode (prediction technique).

It is the same as described in the predictor of the image encoding apparatus 100 that the predictor may generate the prediction signal based on various prediction methods (techniques) which will be described later.

The intra predictor 265 may predict the current block by referring to the samples in the current picture. The description of the intra predictor 185 is equally applied to the intra predictor 265.

The inter predictor 260 may derive a predicted block for the current block based on a reference block (reference sample array) specified by a motion vector on a reference picture. In this case, in order to reduce the amount of motion information transmitted in the inter prediction mode, motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. For example, the inter predictor 260 may configure a motion information candidate list based on neighboring blocks and derive a motion vector of the current block and/or a reference picture index based on the received candidate selection information. Inter prediction may be performed based on various prediction modes, and the information on the prediction may include information indicating a mode of inter prediction for the current block.

The adder 235 may generate a reconstructed signal (reconstructed picture, reconstructed block, reconstructed sample array) by adding the obtained residual signal to the prediction signal (predicted block, predicted sample array) output from the predictor (including the inter predictor 260 and/or the intra predictor 265). If there is no residual for the block to be processed, such as when the skip mode is applied, the predicted block may be used as the reconstructed block. The description of the adder 155 is equally applicable to the adder 235. The adder 235 may be called a reconstructor or a reconstructed block generator. The generated reconstructed signal may be used for intra prediction of a next block to be processed in the current picture and may be used for inter prediction of a next picture through filtering as described below.

The filter 240 may improve subjective/objective image quality by applying filtering to the reconstructed signal. For example, the filter 240 may generate a modified reconstructed picture by applying various filtering methods to the reconstructed picture and store the modified reconstructed picture in the memory 250, specifically, a DPB of the memory 250. The various filtering methods may include, for example, deblocking filtering, a sample adaptive offset, an adaptive loop filter, a bilateral filter, and the like.

The (modified) reconstructed picture stored in the DPB of the memory 250 may be used as a reference picture in the inter predictor 260. The memory 250 may store the motion information of the block from which the motion information in the current picture is derived (or decoded) and/or the motion information of the blocks in the picture that have already been reconstructed. The stored motion information may be transmitted to the inter predictor 260 so as to be utilized as the motion information of the spatial neighboring block or the motion information of the temporal neighboring block. The memory 250 may store reconstructed samples of reconstructed blocks in the current picture and transfer the reconstructed samples to the intra predictor 265.

In the present disclosure, the embodiments described in the filter 160, the inter predictor 180, and the intra predictor 185 of the image encoding apparatus 100 may be equally or correspondingly applied to the filter 240, the inter predictor 260, and the intra predictor 265 of the image decoding apparatus 200.

### Overview of Picture Partitioning

The video/image encoding/decoding method according to the present disclosure may be performed based on a partitioning structure. Specifically, procedures such as prediction, residual processing ((inverse) transform, (de)quantization, etc.), syntax element coding, and filtering may be performed based on a CTU, CU (and/or TU, PU) derived based on the partitioning structure.

The block partitioning procedure may be performed in the image partitioner 110 of the image encoding apparatus. The partitioning related information may be encoded by the entropy encoder 190 and transferred to the image decoding apparatus 200 in the form of a bitstream. The entropy decoder 210 of the image decoding apparatus 200 may derive a block partitioning structure of a current picture based on the partitioning related information obtained from the bitstream, and based on this, may perform a series of procedures (e.g., prediction, residual processing, block/picture reconstruction, in-loop filtering, etc.) for image decoding.

A CU size may be equal to a TU size or a plurality of TUs may be present in a CU region. Meanwhile, the CU size may generally indicate a luma component (sample) CB size. The TU size may generally indicate a luma component (sample) TB size. A chroma component (sample) CB or TB size may be derived based on a luma component (sample) CB or TB size according to a component ratio according to a color format (chroma format, e.g., 4:4:4, 4:2:2, 4:2:0, etc.) of a picture/image. The TU size may be derived based on maxTbSize. For example, when the CU size is greater than maxTbSize, a plurality of TUs (TBs) having maxTbSize may be derived from the CU, and transform/inverse transform may be performed in unit of TU (TB). In addition, for example, when intra prediction is applied, an intra prediction mode/type may be derived in unit of CU (or CB) and a neighboring reference sample derivation and prediction sample generation procedure may be performed in unit of TU (or TB). In this case, one or a plurality of TUs (or TBs) may be present in a CU (or a CB) region. In this case, the plurality of TUs (or TBs) may share the same intra prediction mode/type.

In addition, in video/image encoding and decoding according to the present disclosure, an image processing unit may have a hierarchical structure. One picture may be partitioned into one or more tiles, bricks, slices or tile groups. One brick may include one or more CTU rows in a tile. A slice may include an integer number of bricks of a picture. One tile group may include one or more tiles. One tile may include one or more CTUs. The CTU may be partitioned into one or more CUs. A rectangular region of CTUs within a particular tile column and a particular tile row in a picture. The tile group may include an integer number of tiles according to tile-raster scan within a picture. A slice header may carry information/parameters applicable to the slice (blocks within the slice).

When an image encoding/decoding apparatus 100 or 200 has a multi-core processor, an encoding/decoding procedure for the tile, slice, brick or tile group may be performed in parallel. In the present disclosure, the slice or the tile group may be used interchangeably. That is, the tile group header may be called a slice header. Here, the slice may have one of slice types including an intra (I) slice, a predictive (P) slice and a bi-predictive (B) slice. For blocks in the I slice, inter prediction may not be used and only intra prediction may be used for prediction. Of course, even in this case, an original sample value may be coded and signalled without prediction. For blocks in the P slice, intra prediction or inter prediction may be used, and only uni-prediction may be used when inter prediction is used. Meanwhile, for blocks in the B slice, intra prediction or inter prediction may be used, and up to bi prediction may be used when inter prediction is used.

In the image encoding apparatus 100, a tile/tile group, a brick, a slice, a maximum and minimum coding unit size may be determined according to the characteristics (e.g., resolution) of an image or in consideration of coding efficiency or parallel processing, and information thereon or information capable of deriving the same may be included in a bitstream.

In the image decoding apparatus 200, information indicating whether a tile/tile group, brick or slice of a current picture or a CTU in a tile is partitioned into a plurality of coding units may be obtained. When such information is obtained (transmitted) only under a specific condition, efficiency can increase.

The slice header (slice header syntax) may include information/parameter which is commonly applicable to the slice. The APS (APS syntax) or PPS (PPS syntax) may include information/parameter which is commonly applicable to one or more pictures. The SPS (SPS syntax) may include information/parameter which is commonly applicable to one or more sequences. The VPS (VPS syntax) may include information/parameter which is commonly applicable to multiple layers. The DPS (DPS syntax) may include information/parameter which is commonly applicable to the overall video. The DPS may include information/parameter related to concatenation of a coded video sequence (CVS).

In the present disclosure, a higher level syntax may include at least one of the APS syntax, the PPS syntax, the SPS syntax, the VPS syntax or the slice header syntax. In addition, for example, information on partitioning and configuration of the tile/tile group/brick/slice may be constructed in the image encoding apparatus 100 through the higher level syntax and transferred to the image decoding apparatus 200 in the form of a bitstream.

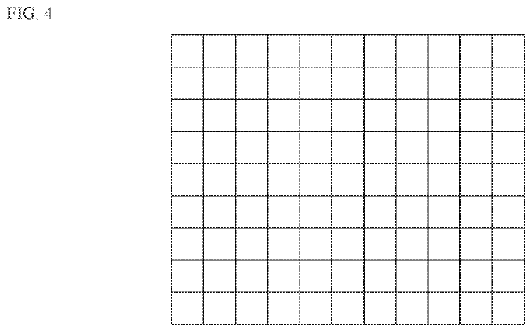

FIG. 4 is a diagram showing an example of partitioning a picture into CTUs. In FIG. 4, a rectangle formed by the outermost border represents a picture and rectangles included in the picture represent CTUs.

Referring to FIG. 4, pictures may be partitioned into a sequence of coding tree units (CTUs). A CTU may correspond to a coding tree block (CTB). Alternatively, the CTU may include a coding tree block of luma samples and two coding tree blocks of chroma samples corresponding thereto. In other words, for a picture containing a three-sample array, the CTU may include an N×N block of luma samples and two corresponding blocks of chroma samples.

The maximum allowable size of the CTU for coding and prediction may be different from the maximum allowable size of the CTU for transform. For example, even if the maximum allowable size of the CTU for transform is 64x×64, the maximum allowable size of the luma block in the CTU for coding and prediction may be 128×128.

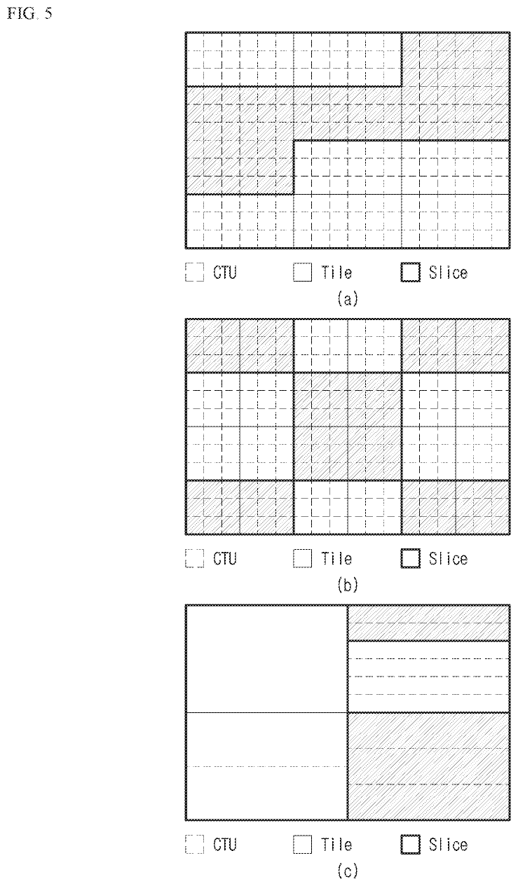

FIG. 5 is a diagram showing examples of partitioning a picture into tiles, slices and/or bricks.

Specifically, (a) of FIG. 5 shows an example of a picture (raster scan slice partition) partitioned into 12 tiles and 3 raster scan slices, and (b) of FIG. 5 shows an example of a picture (rectangular slice partition) partitioned into 24 tiles (6 tile columns and 4 tile rows) and 9 rectangular slices. Additionally, (c) of FIG. 5 shows an example of partitioning a picture into tiles, rectangular slices, and bricks, and in (c) of FIG. 5, the picture is partitioned into four tiles (two tile columns and two tile rows).), 11 bricks (1 brick included in the upper left tile, 5 bricks included in the upper right tile, 2 bricks included in the lower left tile, and 3 bricks included in the lower right tile), and four rectangular slices.

Referring to FIG. 5, the picture may be partitioned into one or more tile rows and one or more tile columns. One tile may be a sequence of CTUs covering a rectangular area of the picture. Depending on the embodiment, a tile may be partitioned into one or more bricks. Each brick may consist of multiple CTU rows within a tile. A tile that is not partitioned into a plurality of bricks may be a brick. However, a brick, which is a subset of tiles, do not correspond to a tile.

A slice may include a plurality of tiles within a picture or a plurality of bricks within a tile. Two slice modes may be supported: raster scan slice mode (raster scan slice) and rectangular slice mode (rectangular slice). In a raster scan slice, one slice may include a sequence of tiles within a tile raster scan of a picture. In a rectangular slice, one slice may include a plurality of bricks that collectively form a rectangular area of a picture. Bricks within a rectangular slice may have a brick raster scan order of the slice.

### Reference Picture Resampling (RPR)

The versatile video coding (VVC) video compression standard technology may use reference picture resampling (RPR) technology in one coded layer video sequence (CLVS). That is, the resolution of an image in one layer image may be changed.

In RPR, when the resolutions of a current image and a reference image are different, a resolution ratio between the reference image and the current image is calculated, and the resolution of the reference image may be changed to a resolution with the same size as the resolution of the current image through sampling. The reference image with the changed resolution may be referenced for encoding/decoding of the current image.

When the resolution of the current image and the resolution of the reference image are different (i.e., when RPR is applied), use of decoder technologies (e.g., coding tools) available when the resolution of the current image and the resolution of the reference image are the same may be restricted. In addition, the resolution of the image changes due to the application of RPR, and the amount of bits and distortion that occurs accordingly changes, so adjustment of quantization parameters is necessary. Furthermore, a method of indicating adaptive resolution (e.g., optimal resolution of the current image) to the image decoding apparatus 200 is also needed.

The present application proposes various embodiments that can solve problems that limit the use of various coding tools when applying RPR and satisfy the need to adjust a quantization parameter and indicate adaptive resolution.

Hereinafter, various embodiments provided herein will be described. Various embodiments described below may be performed individually or may be performed by combining a plurality of embodiments.

### Embodiment

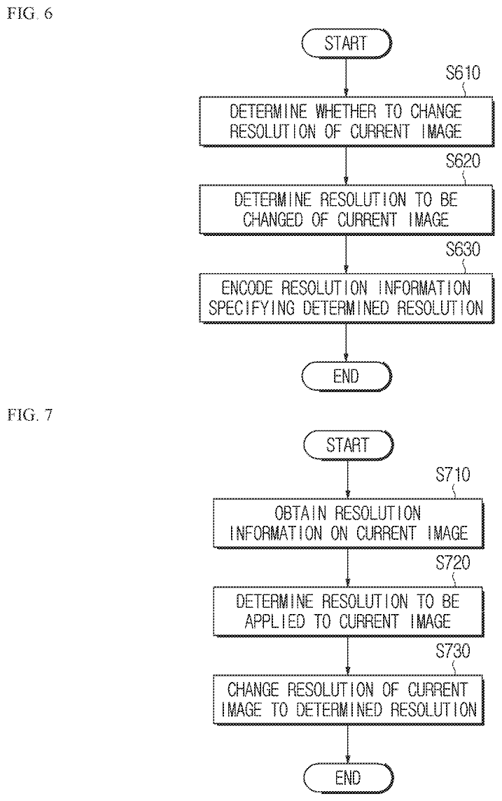

FIG. 6 is a flowchart illustrating an image encoding method according to an embodiment of the present disclosure, and FIG. 7 is a flowchart illustrating an image decoding method according to an embodiment of the present disclosure.

Referring to FIG. 6, the image encoding apparatus 100 may determine whether to change a resolution of a current image (S610).

Whether to change the resolution may be determined by one or more of a PSNR (peak signal to noise ratio), a sample unit average gradient value, or a quantization parameter.

The image encoding apparatus 100 may predict the PSNR for one or more candidate resolutions and determine whether to change the resolution based on the predicted PSNR. For example, the image encoding apparatus 100 may sample the resolution (initial resolution) of an original image as candidate resolutions, sample the resolution of the original image with the sampled resolution back to the initial resolution, and then measure the PSNR between the result and the initial resolution. Through this, by predicting image quality deterioration through the sampling process of the corresponding image, information on the image quality deterioration when the resolution is changed may be predicted.

According to embodiments, instead of predicting the PSNR, the image encoding apparatus 100 may measure complexity of the image by calculating a pixel unit average gradient value for the original image, and determine whether to change a resolution based on the measured complexity.

According to embodiments, the image encoding apparatus 100 may determine whether to change the resolution by comparing a quantization parameter for the current image with a predefined quantization parameter. For example, it may be determined that the resolution is changed when the quantization parameter for the current image has a larger value than the predefined quantization parameter, and it may be determined that the resolution is not changed when the quantization parameter for the current image has a smaller value than the predefined quantization parameter.

According to embodiments, the image encoding apparatus 100 may determine whether to change the resolution based on a combination of the PSNR and the quantization parameter.

Upon determining that the resolution is changed, the image encoding apparatus 100 may determine the resolution to be changed of the current image (S620).

Here, the resolution to be changed of the current image may be an adaptive resolution or optimal resolution. Hereinafter, the resolution to be changed, adaptive resolution, or optimal resolution of the current image is referred to as ‘optimal resolution.’ The optimal resolution may be the resolution that represents the best image quality at the same bit rate or the resolution that represents the lowest bit rate at the same image quality.

The image encoding apparatus 100 may encode resolution information specifying the determined resolution (i.e., optimal resolution) (S630).

The resolution information is information specifying the determined resolution and may be an index, image size, image width, image height, resolution ratio between the current image and reference image, a multiple with a predetermined interval, etc.

Referring to FIG. 7, the image decoding apparatus 200 may obtain resolution information of a current image from a bitstream (S710).

The resolution information is information specifying an optimal resolution and may be an index, image size, image width, image height, resolution ratio between the current image and reference image, a multiple with a predetermined interval, etc.

The image decoding apparatus 200 may determine the resolution (i.e., optimal resolution) to be applied to the current image based on the resolution information (S720). The optimal resolution may be the resolution that represents the best image quality at the same bit rate or the resolution that represents the lowest bit rate at the same image quality. Additionally, the image decoding apparatus 200 may change the resolution of the current image to the determined resolution (i.e., optimal resolution) (S730).

### Embodiment 1

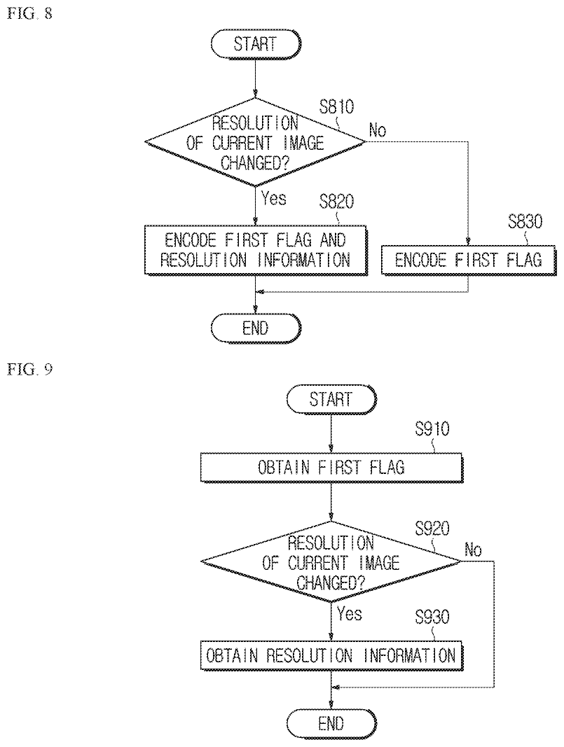

Embodiment 1 is an embodiment of a method of signaling information about whether to use adaptive resolution change. FIG. 8 shows an image encoding method according to Embodiment 1, and FIG. 9 shows an image decoding method according to Embodiment 1.

Referring to FIG. 8, the image encoding apparatus 100 may determine whether to use adaptive resolution change (S810). Whether to use adaptive resolution change may be determined according to the criteria or method described in step S610.

Upon determining that adaptive resolution change is used, the image encoding apparatus 100 may encode a first flag (e.g., adaptive_resolution_chang_flag) and resolution information (S820). In contrast, the image encoding apparatus 100 may encode the first flag (S830), upon determining that adaptive resolution change is not used.

The first flag is information specifying whether adaptive resolution change is used. A first value (e.g., 1) of the first flag may specify that adaptive resolution change is used, and a second value (e.g., 0) of the first flag may specify that adaptive resolution change is not used.

The first flag may be encoded at various levels of the bitstream. As an example, the first flag (e.g., sps_adaptive_resolution_chang_flag) may be encoded and signaled at the SPS level of the bitstream as shown in Table 1.

TABLE 1

| | Descriptor |
|---|---|
| seq_parameter_set_rbsp( ) { | |
| ... | |
| sps_adaptive_resolution_change_flag | u(1) |
| ... | |
| } | |

A first value (e.g., 1) of sps_adaptive_resolution_chang_flag may specify that adaptive resolution change is used in a coded layer video sequence (CLVS) referencing the SPS, and a second value (e.g., 0) of sps_adaptive_resolution_chang_flag may specify that adaptive resolution change is not used in the CLVS referencing the SPS.

As another example, the first flag (e.g., pps_adaptive_resolution_chang_flag) may be encoded and signaled at the PPS level of the bitstream as shown in Table 2.

TABLE 2

| | Descriptor |
|---|---|
| pic_parameter_set_rbsp( ) { | |
| ... | |
| pps_adaptive_resolution_change_flag | u(1) |
| ... | |
| } | |

A first value (e.g., 1) of pps_adaptive_resolution_chang_flag may specify that adaptive resolution change is used in a picture referencing the PPS, and a second value (e.g., 0) of pps_adaptive_resolution_chang_flag may specify that adaptive resolution change is not used in the picture referencing the PPS.

As another example, the first flag (e.g., ph_adaptive_resolution_chang_flag) may be encoded and signaled at the picture header (PH) level of the bitstream, as shown in Table 3.

TABLE 3

| | Descriptor |
|---|---|
| picture_header_structure( ) { | |
| ... | |
| ph_adaptive_resolution_change_flag | u(1) |
| ... | |
| } | |

A first value (e.g., 1) of ph_adaptive_resolution_chang_flag may specify that adaptive resolution change is used in a picture corresponding to the PH, and a second value (e.g., 0) of ph_adaptive_resolution_chang_flag may specify that adaptive resolution change is not used in the picture corresponding to the PH.

As another example, the first flag (e.g., sh_adaptive_resolution_chang_flag) may be encoded and signaled at the slice header (SH) level of the bitstream, as shown in Table 4.

TABLE 4

| | Descriptor |
|---|---|
| slice_header( ) { | |
| ... | |
| sh_adaptive_resolution_change_flag | u(1) |
| ... | |
| } | |

A first value (e.g., 1) of sh_adaptive_resolution_chang_flag may specify that adaptive resolution change is used in a slice corresponding to the SH, and a second value (e.g., 0) of sh_adaptive_resolution_chang_flag may specify that adaptive resolution change is not used in the slice corresponding to the SH.

As another example, the first flag (e.g., adaptive_resolution_chang_flag) may be encoded and signaled at the CTU level of the bitstream as shown in Table 5.

TABLE 5

| | Descriptor |
|---|---|
| coding_tree_unit( ) { | |
| ... | |
| adaptive_resolution_change_flag | u(1) |
| ... | |
| } | |

A first value (e.g., 1) of adaptive_resolution_chang_flag may specify that adaptive resolution change is used in the CTU, and a second value (e.g., 0) of adaptive_resolution_chang_flag may specify that adaptive resolution change is not used in the CTU.

According to embodiments, the first flag may be hierarchically encoded and signaled. That is, the first flag may be encoded at a relatively high level (first level) and a relatively low level (second level) of the bitstream. In this case, if the first flag signaled at the higher level specifies that adaptive resolution change is used, the first flag at the lower level may be signaled.

As an example, as illustrated in Table 6, ph_adaptive_resolution_chang_flag may be encoded and signaled at the PH level when sps_adaptive_resolution_chang_flag or pps_adaptive_resolution_chang_flag signaled at the SPS level or PPS level specifies that adaptive resolution change is used.

TABLE 6

| | Descriptor |
|---|---|
| picture_header_structure( ) { | |
| ... | |
| if ( sps_adaptive_resolution_change_flag ) | |
| ph_adaptive_resolution_change_flag | u(1) |
| ... | |
| } | |

As another example, as illustrated in Table 7, adaptive_resolution_chang_flag may be encoded and signaled at the CTU level when ph_adaptive_resolution_chang_flag or sh_adaptive_resolution_chang_flag signaled at the PH level or SH level specifies that adaptive resolution change is used.

TABLE 7

| | Descriptor |
|---|---|
| coding_tree_unit( ) { | |
| ... | |
| if ( ph_adaptive_resolution_change_flag ) | |
| adaptive_resolution_change_flag | u(1) |
| ... | |
| } | |

Referring to FIG. 9, the image decoding apparatus 200 may obtain the first flag from the bitstream (S910).

The first flag is information specifying whether adaptive resolution change is used. A first value (e.g., 1) of the first flag may specify that adaptive resolution change is used, and a second value (e.g., 0) of the first flag may specify that adaptive resolution change is not used.

The image decoding apparatus 200 may determine whether adaptive resolution change is used based on the first flag (S920). Additionally, the image decoding apparatus 200 may obtain resolution information from the bitstream when adaptive resolution change is used (S930).

### Embodiment 2

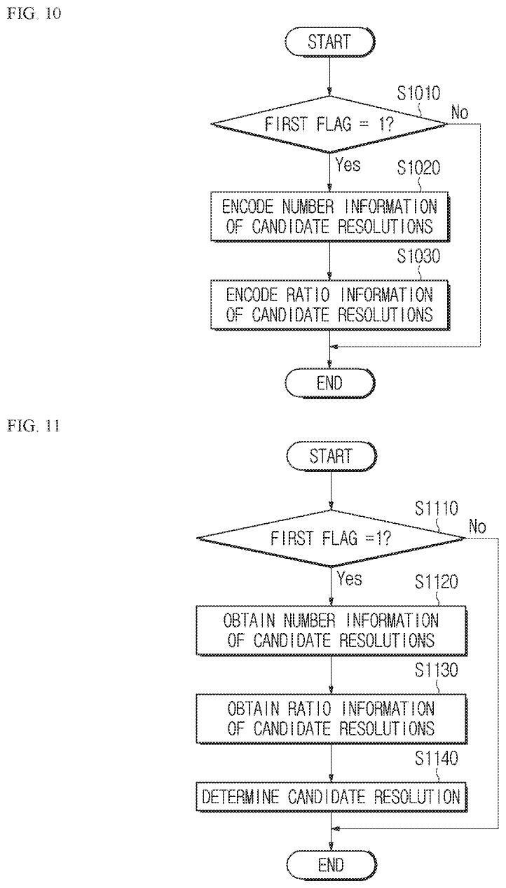

Embodiment 2 is an embodiment of a method of determining one or more candidate resolutions changeable when adaptive resolution is changed. FIG. 10 shows an image encoding method according to Embodiment 2, and FIG. 11 shows an image decoding method according to Embodiment 2.

Resolution information may specify a candidate resolution to be used to change the resolution of a current image among candidate resolutions. The candidate resolution may include number information specifying the number of candidate resolutions and ratio information specifying the ratio of the candidate resolutions.

TABLE 8

| | Descriptor |
|---|---|
| seq_parameter_set_rbsp( ) { | |
| ... | |
| sps_adaptive_resolution_change_flag | u(1) |
| if( sps_adaptive_resolution_change_flag ) | |
| sps_num_resolution_minus1 | u(v) |
| for( i = 0; i <= sps_num_resolution_minus1; i++ ) | |
| sps_resolution_ratio[ i ] | u(v) |
| } | |

Referring to Table 8 and FIG. 10, when the first flag (e.g., sps_adaptive_resolution_chang_flag) has a first value (e.g., 1) (S1010), the image encoding apparatus 100 may encode the number information of the candidate resolutions (e.g., sps_num_resolution_minus1) (S1020).

In addition, the image encoding apparatus 100 may encode the ratio information (e.g., sps_resolution_ratio[i]) of the candidate resolutions by the number indicated by the number information of the candidate resolutions (sps_num_resolution_minus1+1) (S1030).

The number information of the candidate resolutions and the ratio information of the candidate resolutions may be encoded and signaled at a higher level such as PPS or PH as well as SPS.

Referring to Table 8 and FIG. 11, the image decoding apparatus 200 may determine whether adaptive resolution change is used based on the first flag (e.g., sps_adaptive_resolution_chang_flag) (S1110).

When adaptive resolution change is used, the image decoding apparatus 200 may obtain the number information of the candidate resolutions (e.g., sps_num_resolution_minus1) from the bitstream (S1120). Additionally, the image decoding apparatus 200 may obtain the ratio information (e.g., sps_resolution_ratio[i]) of the candidate resolutions from the bitstream by the number indicated by the number information of the candidate resolutions (sps_num_resolution_minus1+1) (S1130).

The image decoding apparatus 200 may determine candidate resolutions based on the number information of the candidate resolutions and the ratio information of the candidate resolutions (S1140). Determination of the candidate resolutions may be determining the ratio of each of the candidate resolutions.

According to embodiments, the ratio information of the candidate resolutions 1) may represent one of the resolution ratios included in a predetermined table (first table), or 2) may include ratio information of a width of the candidate resolutions and the ratio information of a height of the candidate resolutions. In addition, 3) the ratio information of the candidate resolutions may represent a multiple form with regular intervals.

1) The first table may be predefined in the image encoding apparatus 100 and the image decoding apparatus 200. An example of the first table is shown in Table 9.

TABLE 9

| sps_resolution_ratio[ i ] | 0 | 1 | 2 | 3 | 4 | 5 | 6 | 7 | 8 | 9 |
|---|---|---|---|---|---|---|---|---|---|---|
| resolution ratio | 0.25 | 0.5 | 0.75 | 1 | 1.25 | 1.5 | 2 | 4 | 6 | 8 |

In Table 9, the resolution ratio may be expressed as (size of reference image/size of current image). ‘Size’ may be the width or height of the image, or the number of samples in the image (weight*height).

When determining the ratio of candidate resolutions using the first table, the ratio information of the candidate resolutions may be an index specifying one of the resolution ratios included in the first table.

2) The ratio information of the candidate resolutions may include ratio information of the width of the image (ratio information of the width of the candidate resolutions) and ratio information of the height of the image (ratio information of the height of the candidate resolutions).

TABLE 10

| | Descriptor |
|---|---|
| seq_parameter_set_rbsp( ) { | |
| ... | |
| sps_adaptive_resolution_change_flag | u(1) |
| if( sps_adaptive_resolution_change_flag ) | |
| sps_num_resolution_minus1 | u(v) |
| for( i = 0; i <= sps_num_resolution_minus1; i++ ) | |
| sps_resolution_ratio_width[ i ] | u(v) |
| sps_resolution_ratio_height[ i ] | u(v) |
| } | |

In Table 10, sps_resoltion_ratio_width[i] represents ratio information of the width, and sps_resoltion_ratio_height[i] represents ratio information of the height.

3) The ratio information of the candidate resolutions may represent a multiple form with regular intervals.

A multiple form with regular intervals may be ¼, ⅛, etc. For example, when using a ¼ interval, the ratio of candidate resolutions may be derived through Equation 1 below.

ratio of candidate resolutions=0.25*(sps_resolution_ratio[i]+1) [Equation 1]

### Embodiment 3

Embodiment 3 is an embodiment of various examples of resolution information specifying a changed resolution (optimal resolution).

Resolution information may 1) specify one or more of predefined resolution ratios, 2) specify an optimal resolution value, or 3) specify a multiple form with regular intervals.

1) Resolution information may represent one or more of predefined resolution ratios. Here, the predefined resolution ratios may be predefined in the form of a table (second table) in the image encoding apparatus 100 and the image decoding apparatus 200, or may be ratios of candidate resolutions according to the method of Embodiment 2.

For example, as shown in Table 11, the resolution information may be an index (e.g., sps_resolution_ratio_idx) specifying one of the resolution ratios included in the second table.

TABLE 11

| | Descriptor |
|---|---|
| seq_parameter_set_rbsp( ) { | |
| ... | |
| sps_adaptive_resolution_change_flag | u(1) |
| if( sps_adaptive_resolution_change_flag ) | |
| sps_resolution_ratio_idx | u(v) |
| } | |

The resolution ratios included in the second table may represent the resolution ratio between the resolution of the current image and the changed resolution. An example of the second table is shown in Table 12.

TABLE 12

| sps_resolution_ratio_idx | 0 | 1 | 2 | 3 | 4 | 5 | 6 | 7 | 8 | 9 |
|---|---|---|---|---|---|---|---|---|---|---|
| resolution ratio | 0.25 | 0.5 | 0.75 | 1 | 1.25 | 1.5 | 2 | 4 | 6 | 8 |

The resolution ratios included in the second table may be expressed as (size of reference image/size of current image). ‘Size’ may be the width or height of the image, or the number of samples in the image (weight*height).

As another example, as shown in Table 13, the resolution information may include an index specifying the resolution ratio for the width of the image (resolution information in the width direction) and an index specifying the resolution ratio for the height of the image (resolution information in the height direction) among the resolution ratios included in the second table. That is, resolution information may be signaled for each of the width and height of the image.

TABLE 13

| | Descriptor |
|---|---|
| seq_parameter_set_rbsp( ) { | |
| ... | |
| sps_adaptive_resolution_change_flag | u(1) |
| if( sps_adaptive_resolution_change_flag ) | |
| sps_resolution_ratio_idx_width | u(v) |
| sps_resolution_ratio_idx_height | |
| } | |

In Table 13, sps_resolution_ratio_idx_width represents resolution information in the width direction, and sps_resolution_ratio_idx_height represents resolution information in the height direction.

As another example, as shown in Table 14, the resolution information may include an index specifying the resolution ratio for the luma component of the current image (resolution information of the luma component) and an index specifying the resolution ratio for the chroma component of the current image (resolution information of the chroma component) among the resolution ratios included in the second table. That is, the resolution information may be signaled for each of the luma component and chroma component of the image.

TABLE 14

| | Descriptor |
|---|---|
| seq_parameter_set_rbsp( ) { | |
| ... | |
| sps_adaptive_resolution_change_flag | u(1) |
| if( sps_adaptive_resolution_change_flag ) | |
| sps_resolution_ratio_idx_luma | u(v) |
| sps_resolution_ratio_idx_chroma | u(v) |
| } | |

In Table 14, sps_resolution_ratio_idx_luma is resolution information of the luma component and may specify the resolution ratio between the resolution of the luma component and the changed resolution, sps_resolution_ratio_idx_chroma is resolution information of the chroma component and may specify the resolution ratio between the resolution of the chroma component and the changed resolution.

Table 14 shows an example in which the resolution information of the luma/chroma component is implemented in the form of an index, but the resolution information of the luma/chroma component may be implemented in various forms, such as resolution change rate, width and height of the image, etc.

As another example, when the ratio of candidate resolutions is determined using a table (first table) according to the method of Embodiment 2, the resolution information may be an index specifying one or more of the candidate resolution ratios included in the first table.

TABLE 15

| | Descriptor |
|---|---|
| pic_parameter_set_rbsp( ) { | |
| ... | |
| pps_resolution_ratio_idx | u(1) |
| ... | |
| } | |

In Table 15, pps_resolution_ratio_idx represents resolution information, which is an index specifying one or more of candidate resolutions. If candidate resolutions are defined at the SPS level, an index (e.g., pps_resolution_ratio_idx) specifying the changed resolution may be signaled at the PPS level.

The value of pps_resolution_ratio_idx may not be greater than the value of the number information of the candidate resolutions (sps_num_resolution_minus1). The resolution to be applied to the current image (i.e., changed resolution or optimal resolution) may be derived through Equation 2 below.

resolution ratio=sps_resolution_ratio[pps_resolution_ratio_idx] [Equation 2]

In Equation 2, ‘resolution ratio’ represents an optimal resolution.

2) The resolution information may specify an optimal resolution value.

For example, as shown in Table 16, the resolution information may include the width value of the current image whose resolution has been changed (changed to the optimal resolution) and the height value of the current image whose resolution has been changed. That is, the resolution information may be signaled for each of the width and height.

TABLE 16

| | Descriptor |
|---|---|
| seq_parameter_set_rbsp( ) { | |
| ... | |
| sps_pic_width_max_in_luma_samples | ue(v) |
| sps_pic_height_max_in_luma_samples | ue(v) |
| ... | |
| sps_adaptive_resolution_change_flag | u(1) |
| if( sps_adaptive_resolution_change_flag ) | |
| sps_adaptive_pic_width_in_luma_samples | ue(v) |
| sps_adaptive_pic_height_in_luma_samples | ue(v) |
| } | |

In Table 16, sps_adaptive_pic_width_in_luma_samples represents the image width for luma component of the changed resolution, and the sps_adaptive pic_height_in_luma samples represents the image height of the chroma component of the changed resolution.

The optimal resolution (horizontal resolution ratio and vertical resolution ratio) may be determined as in Equation 3 below.

$$horizontal resolution ratio = sps\_adaptive \_pic \_width \_in \_luma \_samples / sps\_pic \_width \_max \_in \_luma \_samples \qquad [ Equation 3 ]$$

$$vertical resolution ratio = sps\_adaptive \_pic \_height \_in \_luma \_samples / sps\_pic \_height \_max \_in \_luma \_samples$$

The horizontal resolution ratio and vertical resolution ratio may be derived to be the same value, or may have different values depending on the application or type of image.

3) The resolution information may represent a multiple form with regular intervals.

The multiple form with regular intervals may be ¼, ⅛, etc. For example, when using a ¼ interval, the resolution ratio may be derived through Equation 4 below.

$$resolution ratio = 0.25 * ( sps\_resolution \_ratio \_idx + 1 ) \qquad [ Equation 4 ]$$

### Embodiment 4

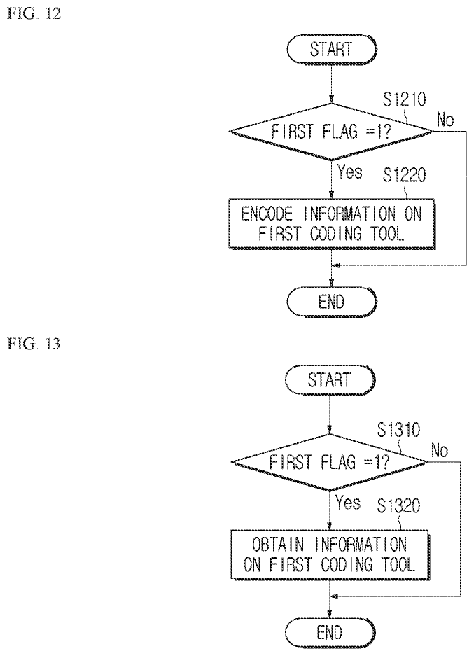

Embodiment 4 is an embodiment of a method of determining whether to apply predetermined coding tools (first coding tools) when adaptive resolution change is used. An image encoding method according to Embodiment 4 is shown in FIG. 12, and an image decoding method according to Embodiment 4 is shown in FIG. 13.

Referring to FIG. 12, when adaptive resolution change is used (S1210), the image encoding apparatus 100 may encode information on a first coding tool (S1220). Referring to FIG. 13, the image decoding apparatus 200 may determine whether adaptive resolution change is used based on a first flag (S1310), and obtain the information on the first coding tool from a bitstream (S1320) when adaptive resolution change is used.

The first coding tool may include one or more of DMVR (decoder side motion vector refinement), BDOF (bi-directional optical flow), PROF (prediction refinement with optical flow), wraparound motion compensation, TMVP (temporal motion vector prediction), and virtual boundary, deblocking filter, sample adaptive offset (SAO), or adaptive loop filter (ALF).

The information on the first coding tool may be information specifying whether the first coding tool is used (activated or not). For example, the information on the first coding tool may include one or more of information specifying whether DMVR is used, information specifying whether BDOF is used, information specifying whether PROF is used, information specifying whether wraparound motion compensation is used, and information specifying whether TMVP is used, information specifying whether a virtual boundary is used, information specifying whether a deblocking filter is used, information specifying whether SAO is used, or information specifying whether an ALF is used.

As an example, when adaptive resolution change is used, information specifying whether DMVR is used (e.g., ph_arc_dmvr_enable_flag) may be signaled as shown in Table 17.

TABLE 17

| | Descriptor |
|---|---|
| picture_header_structure( ) { | |
| ... | |
| if( !pps_rpl_info_in_ph_flag ) | |
| presenceFlag = 1 | |
| else if( num_ref_entries[ 1 ][ RplsIdx[ 1 ] ] > 0 ) | |
| presenceFlag = 1 | |
| if( presenceFlag ) { | |
| ph_mvd_l1_zero_flag | u(1) |
| if( sps_bdof_control_present_in_ph_flag ) | |
| ph_bdof_disabled_flag | u(1) |
| if( sps_dmvr_control_present_in_ph_flag ) | |
| ph_dmvr_disabled_flag | u(1) |
| } | |
| if( !ph_dmvr_disabled_flag && | |
| sps_adaptive_resolution_change_flag ) | |
| ph_arc_dmvr_enable_flag | u(1) |
| ... | |
| } | |

A first value (e.g., 1) of ph_arc_dmvr_enable_flag may specify that DMVR is applied to the corresponding picture, and a second value (e.g., 0) of ph_arc_dmvr_enable_flag may specify that DMVR is not applied to the corresponding picture. When ph_arc_dmvr_enable_flag is not signaled, its value may be derived to be the first value (e.g., 1).

As shown in Table 18, when ph_arc_dmvr_enable_flag is obtained, the image decoding apparatus 200 may derive a dmvrFlag value by adding the condition that the value of ph_arc_dmvr_enable_flag is the first value (e.g., 1), without using RprConstraints ActiveFlag specifying whether RPR is applied to the current picture.

TABLE 18
The decoding process for coding units coded in inter prediction mode consists of the following ordered
steps:
1. The variable dmvrFlag is set equal to 0, the variables cbProfFlagL0 and cbProfFlagL1 are both set
equal to 0, and the variable hpelIfIdx is set equal to 0.
2. The motion vector components and reference indices of the current coding unit are derived as
follows:

| | |
|---|---|
| - | If MergeGpmFlag[ xCb ][ yCb ], inter_affine_flag[ xCb ][ yCb ] and |

merge_subblock_flag[ xCb ][ yCb ] are all equal to 0, the following applies:

| | |
|---|---|
| - | The derivation process for motion vector components and reference indices as specified |

in subclause 8.5.2.1 is invoked with the luma coding block location ( xCb, yCb ), the luma coding block width
cbWidth and the luma coding block height cbHeight as inputs, and the luma motion vectors mvL0[ 0 ][ 0 ]
and mvL1[ 0 ][ 0 ], the reference indices refIdxL0 and refIdxL1 and the prediction list utilization flags
predFlagL0[ 0 ][ 0 ] and predFlagL1[ 0 ][ 0 ], the half sample interpolation filter index hpelIfIdx, and the bi-
prediction weight index bcwIdx as outputs.

| | |
|---|---|
| - | When all of the following conditions are true, dmvrFlag is set equal to 1: |
| - | ph_dmvr_disabled_flag is equal to 0. |
| - | ph_ arc_dmvr_enable_flag is equal to 1. |
| - | general_merge_flag[ xCb ][ yCb ] is equal to 1. |
| - | both predFlagL0[ 0 ][ 0 ] and predFlagL1[ 0 ][ 0 ] are equal to 1. |
| - | mmvd_merge_flag[ xCb ][ yCb ] is equal to 0. |
| - | ciip_flag[ xCb ][ yCb ] is equal to 0. |
| - | DiffPicOrderCnt( currPic, RefPicList[ 0 ][ refIdxL0 ]) is equal to |

DiffPicOrderCnt( RefPicList[ 1 ][ refIdxL1 ], currPic ).

| | |
|---|---|
| - | RefPicList[ 0 ][ refIdxL0 ] is an STRP and RefPicList[ 1 ][ refIdxL1 ] is an STRP. |
| - | bcwIdx is equal to 0. |
| - | Both luma_weight_l0_flag[ refIdxL0 ] and luma_weight_l1_flag[ refIdxL1 ] are equal |

to 0.

| | |
|---|---|
| - | Both chroma_weight_l0_flag[ refIdxL0 ] and chroma_weight_l1_flag[ refIdxL1 ] are |

equal to 0.

| | |
|---|---|
| - | cbWidth is greater than or equal to 8. |
| - | cbHeight is greater than or equal to 8. |
| - | cbHeight*cbWidth is greater than or equal to 128. |

[symbol]

[symbol]

[symbol]

As another example, when adaptive resolution change is used, information specifying whether BDOF is used (e.g., ph_arc_bdof_enable_flag) may be signaled as shown in Table 19.

TABLE 19

| | Descriptor |
|---|---|
| picture_header_structure( ) { | |
| ... | |
| if( !pps_rpl_info_in_ph_flag ) | |
| presenceFlag = 1 | |
| else if( mum ref_entries[ 1 ][ RplsIdx[ 1 ] ] > 0 ) | |
| presenceFlag = 1 | |
| if( presenceFlag ) { | |
| ph_mvd_l1_zero_flag | u(1) |
| if( sps_bdof_control_present_in_ph_flag ) | |
| ph_bdof_disabled_flag | u(1) |
| if( sps_dmivr_control_present_in_ph_flag ) | |
| ph_dmvr_disabled_flag | u(1) |
| } | |
| if( !ph_bdof_disabled_flag && | |
| sps_adaptive_resolution_change_flag ) | |
| ph_arc_bdof_enable_flag | u(1) |
| ... | |
| } | |

A first value (e.g., 1) of ph_arc_bdof_enable_flag may indicate that BDOF is applied to the corresponding picture, and a second value (e.g., 0) of ph_arc_bdof_enable_flag may indicate that BDOF is not applied to the corresponding picture. If ph_arc_bdof_enable_flag is not signaled, its value may be derived to be the first value (e.g., 1).

As shown in Table 20, when ph_arc_bdof_enable_flag is obtained, the image decoding apparatus 200 may derive a bdofFlag value by adding the condition that the value of ph_arc_bdof_enable_flag is the first value (e.g., 1), without using RprConstraintsActiveFlag specifying whether RPR is applied to the current picture.

TABLE 20

| | Let predSamplesL0_{L}, predSamplesL1_{L} and predSamplesIntra_{L} be (cbWidth)x(cbHeight) | |
|---|---|---|
| | arrays of predicted luma sample values and, predSamplesL0_{Cb}, predSamplesL1_{Cb}, | |
| | predSamplesL0_{Cr} and predSamplesL1_{Cr}, predSamplesIntra_{Cb}, and predSamplesIntra_{Cr} be | |
| | (cbWidth / SubWidthC)x(cbHeight / SubHeightC) arrays of predicted chroma sample | |
| | values. | |
| | - | The variable currPic specifies the current picture and the variable bdofFlag is derived |
| | | as follows: |
| - | If all of the following conditions are true, bdofFlag is set equal to TRUE. | |
| | - | ph_bdof_disabled_flag is equal to 0. |
| | - | ph_arc_bdof_enable_flag is equal to 1. |
| | - | predFlagL0[ 0 ][ 0 ] and predFlagL1[ 0 ][ 0 ] are both equal to 1. |
| | - | DiffPicOrderCnt( currPic, RefPicList[ 0 ][ refIdxL0 ] ) is equal to |
| | | DiffPicOrderCnt( RefPicList[ 1 ][ refIdxL1 ], currPic). |
| | - | RefPicList[ 0 ][ refIdxL0 ] is an STRP and RefPicList[ 1 ][ refIdxL1 ] is an STRP. |
| | - | MotionModelIdc[ xCb ][ yCb ] is equal to 0. |
| | - | merge_subblock_flag[ xCb ][ yCb ] is equal to 0. |
| | - | sym_mvd_flag[ xCb ][ yCb ] is equal to 0. |
| | - | ciip_flag[ xCb ][ yCb ] is equal to 0. |
| | - | bcwIdx is equal to 0. |
| | - | luma_weight_l0_flag[ refIdxL0 ] and luma_weight_l1_flag[ refIdxL1 ] are both equal to |
| | | 0. |
| | - | chroma_weight_l0_flag[ refIdxL0 ] and chroma_weight_l1_flag[ refIdxL1 ] are both |
| | | equal to 0. |
| | - | cbWidth is greater than or equal to 8. |
| | - | cbHeight is greater than or equal to 8. |
| | - | cbHeight * cbWidth is greater than or equal to 128. |
| | | [symbol] [symbol] |
| | | [symbol] |
| | - | cIdx is equal to 0. |

| | |
|---|---|
| - | Otherwise, bdofflag is set equal to FALSE. |

As another example, when adaptive resolution change is used, information specifying whether PROF is used (e.g., ph_arc_prof_enable_flag) may be signaled as shown in Table 21.

TABLE 21

| | Descriptor |
|---|---|
| picture_header_structure( ) { | |
| ... | |
| if( sps_prof_control_present_in_ph_flag ) | |
| ph_prof_disabled_flag | u(1) |
| if( !ph_prof_disabled_flag && | |
| sps_adaptive_resolution_change_flag ) | |
| ph_arc_prof_enable_flag | u(1) |
| ... | |
| } | |

A first value (e.g., 1) of ph_arc_prof_enable_flag may specify that PROF is applied to the corresponding picture, and a second value (e.g., 0) of ph_arc_prof_enable_flag may specify that PROF is not applied to the corresponding picture. When ph_arc_prof_enable_flag is not signaled, its value may be derived to be the first value (e.g., 1).

As shown in Table 22, when ph_arc_prof_enable_flag is obtained, the image decoding apparatus 200 may derive a cbprofFlagLX value by adding the condition that the value of ph_arc_prof_enable_flag is the first value (e.g., 1), without using use RprConstraintsActiveFlag specifying whether RPR is applied to the current picture.

TABLE 22
The variable cbProfFlagLX is derived as follows:

| | |
|---|---|
| - | If one or more of the following conditions are true, cbProfFlagLX is set equal to |
| | FALSE. |
| - | ph_prof_disabled_flag is equal to 1. |
| - | ph_arc_prof_enable_flag is equal to 1. |
| - | fallbackModeTriggered is equal to 1. |
| - | numCpMv is equal to 2 and cpMvLX[ 1 ][ 0 ] is equal to cpMvLX[ 0 ][ 0 ] and |
| | cpMvLX[ 1 ][ 1 ] is equal to cpMvLX[ 0 ][ 1 ]. |
| - | numCpMv is equal to 3 and cpMvLX[ 1 ][ 0 ] is equal to cpMvLX[ 0 ][ 0 ] and |
| | cpMvLX[ 1 ][ 1 ] is equal to cpMvLX[ 0 ][ 1 ] and cpMvLX[ 2 ][ 0 ] is equal to |
| | cpMvLX[ 0 ][ 0 ] and cpMvLX[ 2 ][ 1 ] is equal to cpMvLX[ 0 ][ 1 ]. |
| | [symbol] |
| - | Otherwise, cbProfFlagLX set equal to TRUE. |

As another example, when adaptive resolution change is used, information specifying whether a wraparound motion vector is used (e.g., ph_arc_wrapmv_enable_flag) may be signaled as shown in Table 23.

TABLE 23

| | Descriptor |
|---|---|
| picture_header_structure( ) { | |
| ... | |
| if( sps_adaptive_resolution_change_flag ) | |
| ph_arc_wrapmy_enable_flag | u(1) |
| ... | |
| } | |

A first value (e.g., 1) of ph_arc_wrapmv_enable_flag may specify that a wraparound motion vector is applied to the corresponding picture, and a second value (e.g., 0) of ph_arc_wrapmy_enable_flag may specify that the wraparound motion vector is not applied to the corresponding picture. When ph_arc_wrapmy_enable_flag is not signaled, its value may be derived to be the first value (e.g., 1).

As shown in Table 24, when ph_arc_wrapmy_enable_flag is obtained, the image decoding apparatus 200 may derive a refWraparoundEnabledFlag value by adding the condition that the value of ph_arc_wrapmy_enable_flag is the first value (e.g., 1).

TABLE 24

The variable refWraparoundEnabledFlag is set equal to
( pps_ref_wraparound_enabled_flag &&
ph_arc_wrapmv_enable_flag ).

As another example, when adaptive resolution change is used, information specifying whether TMVP is used (e.g., ph_arc_temporal_mvp_enable_flag) may be signaled as shown in Table 25.

TABLE 25

| | Descriptor |
|---|---|
| picture_header_structure( ) { | |
| ... | |
| if( sps_temporal_mvp_enabled_flag ) { | |
| ph_temporal_mvp_enabled_flag | u(1) |
| if( ph_temporal_mvp_enabled_flag && | |
| sps_adaptive_resolution_change_flag ) | |
| ph_arc_temporal_mvp_enable_flag | u(1) |
| ... | |
| } | |

A first value (e.g., 1) of ph_arc_temporal_mvp_enable_flag may specify that TMVP is applied to the corresponding picture, and a second value (e.g., 0) of ph_arc_temporal_mvp_enable_flag may specify that TMVP is not applied to the corresponding picture. When ph_arc_temporal_mvp_enable_flag is not signaled, its value may be derived to be the first value (e.g., 1).

As shown in Table 26, when the value of ph_arc_temporal_mvp_enable_flag is a first value (e.g., 1), TMVP may be used regardless of the value of RprConstraintsActiveFlag, which specifies whether RPR is applied to the current picture, and when the value of ph_arc_temporal_mvp_enable_flag is a second value (e.g., 1), whether to use TMVP may be determined depending on the value of RprConstraintsActiveFlag.

TABLE 26
Let colPicList be set equal to sh_collocated_from_l0_flag ? 0 : 1. It is a requirement of
bitstream conformance that the picture referred to by sh_collocated_ref_idx shall be the
same for all non-l slices of a coded picture, the value of
RprConstraintsActiveFlag[ colPicList ][ sh_collocated_ref_idx ] shall be equal to 0 or
ph_arc_temporal_mvp_enable_flag shall be equal to 1, and the value of
sps_log2_ctu_size_minus5 for the picture referred to by sh_collocated_ref_idx shall be
equal to the value of sps_log2_ctu_size_minus5 for the current picture.

### Embodiment 5

Embodiment 5 is another embodiment of the first coding tool when adaptive resolution change is used.

The first coding tool may further include a resampling filter for resolution change. In this case, the information on the first coding tool may be information specifying a resampling filter selected to change the resolution.

As an example, the information on the first coding tool (information indicating the selected resampling filter) may be a flag or an index. The information on the first coding tool in the form of an index (e.g., ph_arc_resampling_fliter_idx) is shown in Table 27.

TABLE 27

| | Descriptor |
|---|---|
| picture_header_structure( ) { | |
| ... | |
| if( sps_adaptive_resolution_change_flag ) | |
| ph_arc_resampling_filter_idx | u(1) |
| ... | |
| } | |

ph_arc_resampling_fliter_idx may specify a resampling filter to be used for adaptive resolution change among filters (or filter coefficients) included in a filter set. The filter set may be composed of filters or filter coefficients predefined in the image encoding apparatus 100 and the image decoding apparatus 200.

According to embodiments, neural network models classified and trained according to the characteristics of the image regardless of the resolution ratio may be used as a resampling filter. In this case, ph_arc_resampling_fliter_idx may specify a resampling filter to be used for adaptive resolution change among multiple neural network models. The neural network models may be predefined in the image encoding apparatus 100 and the image decoding apparatus 200, or may be signaled separately in sequence or image units through an SEI message or high-level syntax.

### Embodiment 6

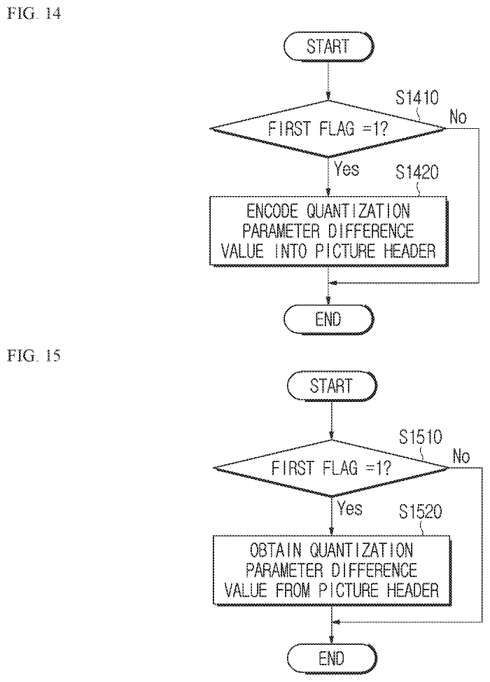

Embodiment 6 is an embodiment of a method of signaling information on a quantization parameter when adaptive resolution change is used. An image encoding method according to Embodiment 6 is shown in FIG. 14, and an image decoding method according to Embodiment 6 is shown in FIG. 15.

Referring to FIG. 14, the image encoding apparatus 100 may encode information on a quantization parameter (S1420) when adaptive resolution change is used (S1410). Referring to FIG. 15, the image decoding apparatus 200 may determine whether adaptive resolution change is used based on a first flag (S1510), and obtain the information on the quantization parameter from a bitstream (S1520) when adaptive resolution change is used.

The information on the quantization parameter may include a quantization parameter difference value (e.g., ph_qp_delta). An example of signaling the quantization parameter difference value is shown in Table 28.

TABLE 28

| | Descriptor |
|---|---|
| picture_header_structure( ) { | |
| ... | |
| if( pps_qp_delta_info_in_ph_flag \|\| | |
| ph_adaptive_resolution_change_flag ) | |
| ph_qp_delta | u(1) |
| ... | |
| } | |

ph_qp_delta may represent a difference value from the quantization value signaled at the PPS level to determine an initial value of the quantization parameter used for the current picture. A first value (e.g., 1) of pps_qp_delta_info_in_ph_flag may specify that the initial value of the quantization parameter is defined at the PH level, and a second value (e.g., 0) of pps_qp_delta_info_in_ph_flag may specify that the initial value of the quantization parameter is defined at the SH level in slice units. That is, when adaptive resolution change is applied, the initial value of the quantization parameter may be determined in picture units.

According to embodiments, when adaptive resolution change is used, the quantization parameter difference value may not be signaled separately, and a predetermined quantization parameter difference value may be used depending on the resolution.

The initial value SliceQpy of the quantization parameter may be derived as shown in Table 29 below.

TABLE 29
ph_qp_delta specifies the initial value of Op_{y} to be used for the coding blocks in the
picture until modified by the value of CuQpDeltaVal in the coding unit layer.
When pps_qp_delta_info_in_ph_flag is equal to 1, the initial value of the Qp_{y} quantization
parameter for all slices of the picture, SliceQp_{y}, is derived as follows:
SliceQp_{y} = 26 + pps_init_qp_minus26 + ph_qp_delta + arcQpOffset[arcRatioIdx]

The arcQpOffset value represents an additional quantization parameter difference value according to adaptive resolution change, and may be derived by referring to Table 30 according to the resolution ratio.

TABLE 30

| arcRatioIdx | 0.25 | 0.5 | 0.75 | 1 | 1.25 | 1.5 | 2 | 4 | 6 | 8 |
|---|---|---|---|---|---|---|---|---|---|---|
| arcQpOffset(arcRatioIdx) | −9 | −6 | −3 | 0 | 1 | 3 | 6 | 9 | 12 | 15 |

The quantization parameter values expressed in Table 30 are only one example of quantization parameter values, and a quantization parameter difference value that may be easily derived or inferred by those skilled in the art may be used.

According to embodiments, the arcQpOffset value may be explicitly signaled at a higher level.

### Embodiment 7

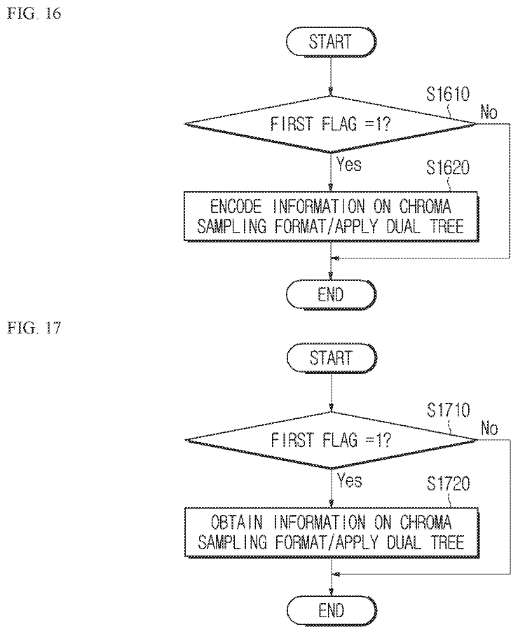

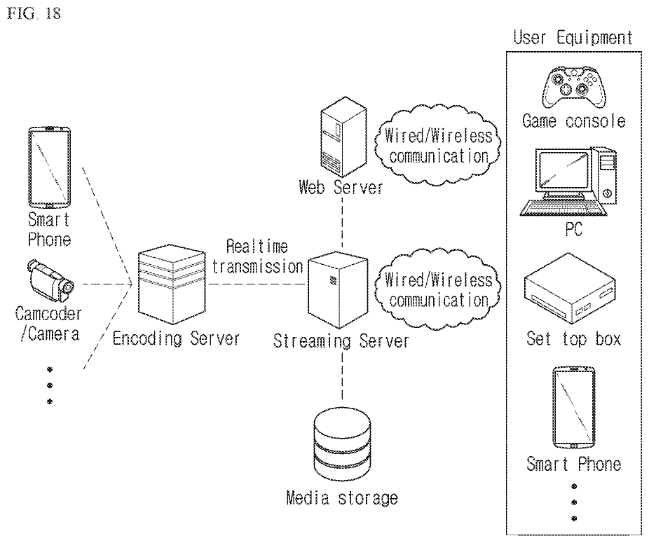

Embodiment 7 is an embodiment of a method of changing a chroma sampling format of an image or applying dual tree technology when adaptive resolution change is applied. An image encoding method according to Embodiment 7 is shown in FIG. 16, and an image decoding method according to Embodiment 7 is shown in FIG. 17.

Referring to FIG. 16, when adaptive resolution change is used (S1610), the image encoding apparatus 100 may encode information on a chroma sampling format (S1620).

Referring to FIG. 17, the image decoding apparatus 200 may determine whether adaptive resolution change is used based on a first flag (S1710), and determine that the information on the chroma sampling format is obtained from a bitstream or a dual tree is applied (S1720) when adaptive resolution change is used.

When adaptive resolution change is applied, the chroma sampling format of the current image may have a different value from the sps_chroma_format_idc value, which is information on the chroma sampling format signaled at the SPS level. According to the present application, a chroma sampling format changed by application of adaptive resolution change may be additionally signaled. Information on the additionally signaled chroma sampling format (e.g., ph_chroma_format_idc) is shown in Table 31.

TABLE 31

| | Descriptor |
|---|---|
| picture_header_structure( ) { | |
| ... | |
| if(ph_adaptive_resolution_change_flag ) | |
| ph_chroma_format_idc | u(1) |
| ... | |
| } | |

Changing the sampling format may have a similar effect as signaling the ratio of adaptive resolution with respect to each of the luma component and chroma component. For example, for a 4:2:0 format image, if only the luma component is changed to ½ resolution and the resolution of the chroma component is not changed, it has the same effect as changing it to 4:4:4 format.

According to embodiments, as shown in Table 32, the dual tree technology that separates and encodes the luma component and the chroma component may be constrained to be used when adaptive resolution change is applied.

TABLE 32

Descriptor

```
coding_tree_unit( ) {
...
  if( sh_slice_type == I && (sps_qtbtt_dual_tree_intra_flag || ph_{—}
adaptive_resolution_change_flag) )
    dual_tree_implicit_qt_split( xCtb, yCtb, CtbSizeY, 0 )
  else
    coding_tree( xCtb, yCtb, CtbSizeY, CtbSizeY, 1, 1, 0, 0, 0, 0, 0,
      SINGLE_TREE, MODE_TYPE_ALL )
}
```

In Table 32, ph_adaptive_resolution_change_flag specifies whether adaptive resolution change is used in the current image, and when ph_adaptive_resolution_change_flag specifies that adaptive resolution change is used, dual tree coding/decoding may be applied to the corresponding picture.

FIG. 18 is a view illustrating a content streaming system, to which an embodiment of the present disclosure is applicable.

As shown in FIG. 18, the content streaming system, to which the embodiment of the present disclosure is applied, may largely include an encoding server, a streaming server, a web server, a media storage, a user device, and a multimedia input device.

The encoding server compresses content input from multimedia input devices such as a smartphone, a camera, a camcorder, etc, into digital data to generate a bitstream and transmits the bitstream to the streaming server. As another example, when the multimedia input devices such as smartphones, cameras, camcorders, etc, directly generate a bitstream, the encoding server may be omitted.

The bitstream may be generated by an image encoding method or an image encoding apparatus, to which the embodiment of the present disclosure is applied, and the streaming server may temporarily store the bitstream in the process of transmitting or receiving the bitstream.

The streaming server transmits the multimedia data to the user device based on a user's request through the web server, and the web server serves as a medium for informing the user of a service. When the user requests a desired service from the web server, the web server may deliver it to a streaming server, and the streaming server may transmit multimedia data to the user. In this case, the content streaming system may include a separate control server. In this case, the control server serves to control a command/response between devices in the content streaming system.

The streaming server may receive content from a media storage and/or an encoding server. For example, when the content is received from the encoding server, the content may be received in real time. In this case, in order to provide a smooth streaming service, the streaming server may store the bitstream for a predetermined time.

Examples of the user device may include a mobile phone, a smartphone, a laptop computer, a digital broadcasting terminal, a personal digital assistant (PDA), a portable multimedia player (PMP), navigation, a slate PC, tablet PCs, ultrabooks, wearable devices (e.g., smartwatches, smart glasses, head mounted displays), digital TVs, desktops computer, digital signage, and the like.

Each server in the content streaming system may be operated as a distributed server, in which case data received from each server may be distributed.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

The embodiments of the present disclosure may be used to encode or decode an image.

1. An image decoding method performed by an image decoding apparatus, the image decoding method comprising:
obtaining resolution information on a current image from a bitstream;
determining a resolution to be applied to the current image based on the resolution information; and
changing a resolution of the current image to the determined resolution.

2. The image decoding method of claim 1, wherein the resolution information specifies one of one or more candidate resolutions.

3. The image decoding method of claim 2,
wherein the candidate resolutions are determined based on number information of the candidate resolutions and ratio information of the candidate resolutions, and
wherein the number information and the ratio information are obtained from the bitstream.

4. The image decoding method of claim 3, wherein the ratio information specifies one of one or more resolution ratios included in a predetermined table.

5. The image decoding method of claim 3, wherein the ratio information comprises ratio information for a width of the candidate resolutions and ratio information for a height of the candidate resolutions.

6. The image decoding method of claim 1,
wherein the resolution information comprises resolution information in a width direction and resolution information in a height direction, and
wherein the resolution information in the width direction specifies one of one or more candidate resolution information included in a predetermined table, and the resolution information in the height direction specifies one of the candidate resolution information included in the predetermined table.

7. The image decoding apparatus of claim 1, wherein the resolution information comprises a width value of the current image whose resolution has been changed and a height value of the current image whose resolution has been changed.

8. The image decoding apparatus of claim 1, wherein the resolution information comprises resolution information on a luma component of the current image and resolution information on a chroma component of the current image.

9. The image decoding apparatus of claim 1, wherein the resolution information is obtained from the bitstream based on a first flag obtained from the bitstream specifying that resolution change is applied.

10. The image decoding apparatus of claim 9,
wherein the first flag is obtained from a first level of the bitstream and the resolution information is obtained from a second level of the bitstream, and
wherein the first level is a higher level than the second level.

11. The image decoding apparatus of claim 1, further comprising obtaining information on a first coding tool based on a first flag obtained from the bitstream specifying that resolution change is applied.

12. The image decoding apparatus of claim 11, wherein the information on the first coding tool comprises one or more of information specifying whether decoder side motion vector refinement (DMVR) is used, information specifying whether bi-directional optical flow (BDOF) is used, information specifying whether prediction refinement with optical flow (PROF) is used, information specifying whether wraparound motion compensation is used, information specifying whether temporal motion vector prediction (TMVP) is used, or information specifying a resampling filter for resolution change.

13. The image decoding method of claim 1, further comprising obtaining a quantization parameter difference value from a picture header of the bitstream based on a first flag obtained from the bitstream specifying that resolution change is applied.

14. An image encoding method performed by an image encoding apparatus, the image encoding method comprising:
determining whether a resolution of a current image is changed;
determining a resolution to be changed of the current image based on determining that the resolution of the current image is changed; and
encoding resolution information specifying the determined resolution.

15. A computer-readable recording medium storing a bitstream generated by the image encoding method of claim 14.

16. A method of transmitting a bitstream generated by an image encoding method, the image encoding method comprising:
determining whether a resolution of a current image is changed;
determining a resolution to be changed of the current image based on determining that the resolution of the current image is changed; and
encoding resolution information specifying the determined resolution.
